(19) United States
(12) Patent Application Publication
(10) Pub. No.: US 2017/0362750 A1
(43) Pub. Date: Dec. 21, 2017

(54) SKIN MATERIAL AND METHOD OF PRODUCING SKIN MATERIAL

(71) Applicant: Kyowa Leather Cloth Co., Ltd., Shizuoka (JP)

(72) Inventors: Tadahisa Sasase, Shizuoka (JP); Atsushi Yamada, Shizuoka (JP); Koji Sugiura, Shizuoka (JP)

(21) Appl. No.: 15/537,796

(22) PCT Filed: Dec. 11, 2015
(86) PCT No.: PCT/JP2015/084834

§ 371 Date: Jun. 19, 2017

(30) Foreign Application Priority Data
Dec. 26, 2014 (JP) 2014-266544

(51) Int. Cl. D04B 1/02; B32B 27/12; B32B 27/40; D06N 3/14

(52) U.S. Cl. CPC D04B 1/02; D06N 3/14; B32B 27/12; B32B 27/40

(57) ABSTRACT

A skin material includes a loop pile fabric including fibers including polyester fibers, and an adhesive layer and a skin layer, which are disposed, in this order, on a surface of the loop pile fabric at a side at which pile yarns are provided, in which at least top parts of the pile yarns are located in the adhesive layer, and a gap is formed between a ground structure of the loop pile fabric and the adhesive layer.

### TECHNICAL FIELD

The present invention relates to a skin material and a method of producing a skin material.

### BACKGROUND ART

Synthetic resin skin materials having excellent durability have been frequently applied to automobile interior parts such as instrument panels, door trims, seats, and ceilings, interior parts of train vehicles and aircrafts such as trims, seats, and ceilings, furniture, shoes, footwear, bags, interior and exterior materials for construction, outer covering materials and linings for clothes, wall covering materials, and the like, in place of generally used natural leathers or fabric sheets. Some of such synthetic resin skin materials have, on the outermost surface thereof, unevenness similar to unevenness that natural leathers have, that is, embossed patterns. Such embossed patterns of skin materials characterize their appearances.

In particular, seat skin materials applied to automobile seats, chairs, and the like preferably offer appropriate cushioning characteristics and a soft texture in order to achieve a comfortable sitting sensation. Further, skin materials preferably have appropriate stretchability and durability.

Therefore, a skin material that includes a ground fabric as a base material, in which a polyurethane foam layer is provided at the back side of the ground fabric for imparting cushioning characteristics and a skin layer is provided at the outermost surface thereof for imparting a design property, is used generally. Further, for imparting softness to a skin material, use of a raised ground fabric as a base material has been attempted.

Hereinafter, a cloth (fabric) used herein as a base material is also referred to as “ground fabric”.

For the purpose of providing a synthetic leather having high durability and an improved texture, a synthetic leather, in which a raised knitted fabric formed by special knitting using a spun yarn is used as a ground fabric, a urethane-based adhesive layer and a polyurethane skin layer are provided on a raised surface of the ground fabric, and 20% to 99% of the length of raised fibers are located in the adhesive layer, has been proposed (for example, see Japanese Patent Application Laid-Open (JP-A) No. H9-111671).

Further, for the purpose of imparting a soft texture to a skin layer, as an automobile interior material having a layer formed by wet processing, an interior material having, on a raised surface of a fabric having raised fibers, a microporous layer formed by a wet process, a polyurethane adhesion layer, and a urethane skin layer, in which the top parts of the raised fibers of a ground fabric are located in the polyurethane adhesion layer, has been proposed (for example, see JP-A No. H7-132573).

As a synthetic leather having a rich volume appearance produced without using a wet processing method, a synthetic leather, in which a skin layer is formed on a raised surface of a fibrous base material that is coated or impregnated with a water-in-oil dispersion of a urethane-based resin, has been proposed (for example, see JP-A No. H6-294077).

### SUMMARY OF INVENTION

Although the synthetic leather according to JP-A No. H9-111671 has a favorable texture, there is still need for improvement of cushioning characteristics, for example, when applied to a seat.

In the interior material described in JP-A No. H7-132573, layers are formed by wet processing. Therefore, the interior material has improved rich volume appearance and texture. However, the wet processing method includes a process of exchanging a solvent in water for a fabric having a microporous layer, and thus requires special processing equipment. Therefore, a method in which wet processing is not applied i desired from the viewpoint of productivity. Further, the interior material described in JP-A No. H7-132573 has still need for improvement of peel strength between the microporous layer formed by wet processing and the skin layer.

The synthetic leather described in JP-A No. H6-294077 is readily manufactured and has improved rich volume appearance and texture, but there is still need for improvement of cushioning characteristics.

An object of the present invention is to provide a skin material having a soft texture, an appropriate elasticity, and excellent peel strength between a base material and a skin layer.

Another object of the invention is to provide a method of producing a skin material having a soft texture, an appropriate elasticity, and excellent peel strength between a base material and a skin layer, at high productivity.

As a result of the intensive studies, the inventors have found that the above problems can be solved by using a loop pile fabric including fibers including polyester fibers as a ground fabric, and forming a gap between a ground structure of the loop pile fabric and an adhesive layer formed on a surface of the loop pile fabric, whereby the invention has been made.

Namely, the invention includes the following embodiments.

<1> A skin material including:

a loop pile fabric including fibers including polyester fibers, and

an adhesive layer and a skin layer, which are disposed, in this order, on a surface of the loop pile fabric at a side at which pile yarns are provided,

wherein at least top parts of the pile yarns are located in the adhesive layer, and a gap is formed between a ground structure of the loop pile fabric and the adhesive layer.

<2> The skin material according to <1>, wherein, in the loop pile fabric, the pile yarns are provided on one side of the ground structure.

<3> The skin material according to <1> or <2>, wherein the adhesive layer includes polyurethane.

<4> The skin material according to any one of <1> to <3>, wherein the adhesive layer includes bubbles.

<5> A method of producing a skin material, the method including:

a layered body forming process of forming a layered body having, on a surface of a release material, a layer of a composition for forming a skin layer and a layer of a composition for forming an adhesive layer, by applying the composition for forming a skin layer onto the surface of the release material, to form the layer of the composition for forming a skin layer, and applying the composition for forming an adhesive layer onto a surface of the layer of the composition for forming a skin layer, to form the layer of the composition for forming an adhesive layer;

a pressurizing process of bringing the layer of the composition for forming an adhesive layer of the obtained layered body, into contact with a surface of a loop pile fabric, including fibers including polyester fibers, at a side at which pile yarns are provided, and applying pressure thereto; and

a heating process of releasing from the pressure applied to the loop pile fabric and the layered body and thereafter applying heat thereto with a heating means, such that the layer of the composition for forming a skin layer and the layer of the composition for forming an adhesive layer are cured to form a skin layer and an adhesive layer,

wherein the skin material includes the adhesive layer and the skin layer, which are disposed, in this order, at least top parts of the pile yarns are located in the adhesive layer, and a gap is formed between a ground structure of the loop pile fabric and the adhesive layer.

<6> A method of producing a skin material, the method including:

a layered body forming process of forming a layered body having, on a surface of a release material, a layer of a composition for forming a skin layer and a layer of a composition for forming an adhesive layer, by applying the composition for forming a skin layer onto the surface of the release material, to form the layer of the composition for forming a skin layer, and applying the composition for forming an adhesive layer onto a surface of the layer of the composition for forming a skin layer, to form a layer of the composition for forming an adhesive layer;

a pressurizing process of drying the layered body by heating with a heating means, and thereafter bringing a surface of a loop pile fabric, at a side at which pile yarns are provided, into contact with the layer of the composition for forming an adhesive layer of the obtained layered body, and applying pressure thereto at room temperature or with heating; and

a process of releasing the pressure applied to the loop pile fabric and the layered body,

wherein a skin material includes the adhesive layer and the skin layer, which are disposed, in this order, at least top parts of the pile yarns are located in the adhesive layer, and a gap is formed between a ground structure of the loop pile fabric and the adhesive layer.

<7> The method of producing a skin material according to <5> or <6>, wherein the heating means is a non-contact heating means or a single-side contact heating means.

<8> The method of producing a skin material according to any one of <5> to <7>, wherein the heating with a heating means includes forming an adhesive layer including bubbles by expanding a blowing agent contained in the layer of the composition for forming an adhesive layer, or by fixing bubbles contained in the layer of the composition for forming an adhesive layer.

### Advantageous Effects of Invention

According to the first embodiment of the invention, a skin material having a soft texture, an appropriate elasticity, and excellent peel strength between a base material and a skin layer, can be obtained.

Further, according to the second embodiment of the invention, a method of producing a skin material having a soft texture, an appropriate elasticity, and excellent peel strength between a base material and a skin layer, at high productivity, can be obtained.

### BRIEF DESCRIPTION OF DRAWING

FIG. 1 is a schematic cross-sectional view showing an aspect of a skin material according to the invention.

### DESCRIPTION OF EMBODIMENTS

Hereinbelow, the invention is described in detail.

### Skin Material

A skin material according to the invention is a skin material including a loop pile fabric including fibers including polyester fibers, and an adhesive layer and a skin layer, which are disposed, in this order, on a surface of the loop pile fabric at a side at which pile yarns are provided, in which at least top parts of the pile yarns are located in the adhesive layer, and a gap is formed between a ground structure of the loop pile fabric and the adhesive layer.

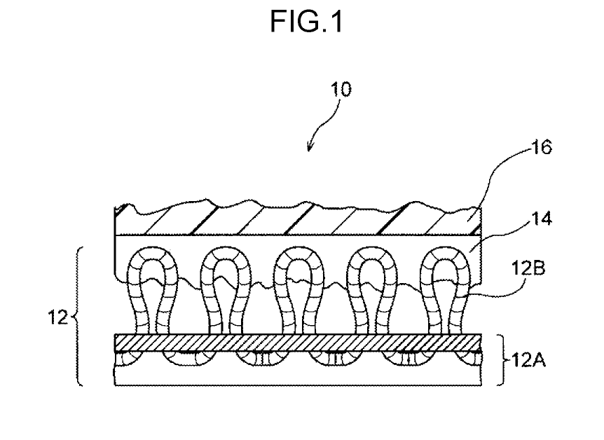

FIG. 1 is a schematic cross-sectional view showing an aspect of a skin material 10 according to the invention.

In the skin material 10 according to the present embodiment, a loop pile fabric 12 including fibers including polyester fibers is used as a base material.

In the loop pile fabric 12 used according to the present embodiment, looped pile yarns 12B are provided on one side of a ground structure 12A.

According to the present embodiment, a skin layer 16 is formed on a surface of the loop pile fabric 12, at a side at which the pile yarns 12B are provided, via an adhesive layer 14.

Although the action of the invention is not very clear, it is conceived as follows.

In the skin material 10 according to the first embodiment of the invention, the loop pile fabric 12 including fibers including polyester fibers is used as a base material. Therefore, the skin material 10 has favorable softness and strength of the fabric itself, and has favorable cushioning characteristics due to the looped pile yarns 12B of the fabric.

It is conceivable that since top parts of the pile yarns 12B are located in the adhesive layer 14 formed on a surface of the loop pile fabric 12 at a side at which the pile yarns 12B are provided, the peel strength between the adhesive layer 14 and the base fabric 12 is favorable, and therefore the peel strength between the skin layer 16 provided on a surface of the adhesive layer 14 and the ground fabric 12 is also favorable.

Further, a gap is formed between the ground structure 12A of the loop pile fabric 12 and the adhesive layer 14, and therefore it is conceivable that the skin material 10 according to the invention is a skin material that has a soft texture, as well as a high peel strength and favorable cushioning characteristics without using a material having an especially high strength or providing a soft resin layer formed by a wet method, due to the inherent cushioning characteristics possessed by the loop pile fabric 12, and the cushioning characteristics of the adhesive layer 14 formed with a synthetic resin, as well as cushioning characteristics of an air layer formed between the ground structure 12A of the fabric and the adhesive layer 14.

According to a preferable aspect of the invention, the adhesive layer 14 includes bubbles. In this case, the skin material 10 according to the invention has favorable cushioning characteristics compared to a case in which the skin material 10 includes an adhesive that does not include bubbles.

In a method of producing a skin material according to the second embodiment of the invention, a layer of a composition for forming a skin layer and a layer of a composition for forming an adhesive layer are formed on a surface of a release material, and a surface of a loop pile fabric, at a side at which pile yarns 12B are provided, is brought into contact with the layer of the composition for forming an adhesive layer, and pressure is applied thereto, as a result of which top parts of the pile yarns 12B of a loop pile fabric 12 penetrate into the adhesive layer. Thereafter the pressure is released and a heating process is performed to form an adhesive layer 14 and a skin layer 16 by heating and curing. Since the adhesive layer 14 is cured in a state in which the top parts of the pile yarns 12B remain in the layer of the composition for forming an adhesive layer, favorable peel strength between the loop pile fabric 12 and the adhesive layer 14 can be obtained. Further, when pressure is applied to the layer of the composition for forming an adhesive layer and a surface of the loop pile fabric 12 at a side at which the pile yarns 12B are provided, and then the pressure is released, a gap is formed between the layer of the composition for forming an adhesive layer and a ground structure 12A of the loop pile fabric 12 due to the elasticity of the pile yarns 12B. Further, during curing of the layer of the composition for forming a skin layer and the layer of the composition for forming an adhesive layer, volume contraction occurs due to the formation of a cross-linked structure or removal of a solvent, whereby the gap between the formed adhesive layer 14 and the ground structure 12A of the loop pile fabric 12 is fixed. Consequently, it is conceivable that, according to the method of producing a skin material 10 of the second embodiment of the invention, a skin material having a soft texture and an appropriate elasticity, as well as favorable peel strength between a base material and a skin layer, can be easily produced.

The loop pile fabric 12 is used as a ground fabric of the skin material 10 according to the invention. The loop pile fabric 12 is a ground fabric in which the pile yarns 12B are provided on at least one side of the ground structure 12A constituting the loop pile fabric 12.

In one embodiment of the invention shown in FIG. 1, in the loop pile fabric 12, the pile yarns 12B are provided on one side of the ground structure 12A.

The loop pile fabric 12 has a structure of a knitted fabric.

The loop pile fabric 12 with the pile yarns 12B in loop form can be obtained by forming loops by regularly raising, in wheel form, parts of a weft of a double-warp knitted fabric or a double-weft knitted fabric.

Since the loop pile fabric 12 has a loop pile structure with the pile yarns 12B in loop form, the cushioning characteristics and the resistance to peeling between the ground fabric and the skin layer of the obtained skin material can be improved. Therefore, in terms of favorable cushioning characteristics and resistance to peeling between the ground fabric and the skin layer, the loop pile fabric 12 is used as a ground fabric in the skin material 10 according to the first embodiment of the invention.

The loop pile fabric described herein does not encompass a warp knitted fabric such as tricot knit fabric, nor a weft knitted fabric such as jersey knit fabric or stockinette stitch.

The fibers constituting the loop pile fabric 12 include polyester fibers. In a case in which polyester fibers are included, the loop pile fabric 12 may be superior in durability and softness. Fibers constituting the loop pile fabric 12 (hereinafter also referred to simply as “fibers”) may be fibers including solely polyester fibers, or fibers including polyester fibers and other fibers. The content of the polyester fibers included in the fibers constituting the loop pile fabric 12 is preferably 50% by mass or more, more preferably 60% by mass or more, and still more preferably 100% by mass.

Examples of fibers, which may be included in the fibers constituting the loop pile fabric 12, other than polyester fibers include a polyamide fiber, a Kevlar fiber which is a high strength polyamide fiber, a polyurethane fiber, a cotton fiber, a hemp fiber, a rayon fiber, and nylon fiber. For example, by using a combination of a polyester fiber and a polyurethane fiber, the elasticity of the loop pile fabric 12 can be improved. Further, by using a combination of a polyester fiber and a polyurethane fiber, the strength of the loop pile fabric 12 can be further enhanced.

The fiber constituting the loop pile fabric 12 may be a monofilament or a twisted yarn, and is preferably a twisted yarn since the adherence between the adhesive layer 14 and the pile yarns 12B may be improved.

Although the fineness of a fiber constituting the loop pile fabric 12 is not particularly limited, a polyester fiber of from 56 dtex to 167 dtex, and with from 17 filaments to 72 filaments is preferable in order to achieve sufficient rebound resilience, as well as strength and softness.

The thickness of the loop pile fabric 12, more particularly the total thickness of the loop pile fabric 12, and the thickness of the ground structure 12A, the length of the pile yarns 12B, the thickness of a fiber that can be used for production of the loop pile fabric 12, and the density of a fabric structure may be selected appropriately according to the intended use of the skin material 10.

Here, the length of pile yarns 12B means a distance from the surface of the ground structure 12A of the loop pile fabric 12 to the top of a free end of the pile yarns 12B.

For example, in a case in which the skin material 10 according to the invention is used as a skin material for a seat, the thickness of the loop pile fabric 12 is preferably from 0.5 mm to 3.0 mm, and the length of the pile yarns 12B is preferably in a range of from 0.6 mm to 1.5 mm, for the purpose of improving cushioning characteristics.

As the loop pile fabric 12, a commercially available product may be used. Examples of the commercially available product of the loop pile fabric 12 that can be used as the skin material 10 according to the first embodiment of the invention include a plating sinker pile knitted fabric (produced by Shinwa Co.) and a wrap sinker pile knitted fabric (produced by Shinwa Co.).

Skin Layer

The skin material 10 according to the invention has the skin layer 16 on a surface of the loop pile fabric 12, at a side at which the pile yarns 12B are provided, via the adhesive layer 14.

A design feature suitable for the intended use of the skin material 10 may be imparted to the skin layer 16. The method of forming a skin layer 16 is not particularly limited, and a well-known method of forming a synthetic leather, or a skin layer that can be used for a skin material may be applied to form a skin layer.

The synthetic resin that can be used for forming the skin layer 16 is not particularly limited, and may be selected appropriately according to the intended use.

Examples of synthetic resin that can be used for forming a skin layer include polyurethane, a vinyl chloride resin, an acrylic resin, and polyester. Among these, polyurethane is preferable in terms of superior durability and elasticity.

Examples of polyurethane that can be used for forming the skin layer 16 include polycarbonate-based polyurethane, polyether-based polyurethane, polyester-based polyurethane, and a modified product thereof. In terms of applying the skin material according to the invention to a material requiring long term durability, such as an automobile seat or a chair, polycarbonate-based polyurethane is preferable.

A commercially available product may be used as polyurethane. Preferable examples of the commercially available product that can be used in the invention include CRISVON (produced by DIC Corporation).

In a case in which polyurethane is used for forming the skin layer 16, the hardness of polyurethane measured according to JIS K-6301 in terms of 100% modulus is from 0.49 MPa to 9.8 MPa, and preferably from 1.96 MPa to 5.88 MPa.

Examples of methods of adjusting the hardness (100% modulus) of polyurethane include, for softening the polyurethane, a method of increasing the content of a polyol component as a soft segment or increasing the molecular weight of a polyol; and for hardening the polyurethane, a method of increasing a urethane bond and/or a urea bond as a hard segment, and/or adding a crosslinking agent, such as hexamethylene diisocyanate (HDI), hydrogenated xylylene diisocyanate (hydrogenated XDI), isophorone diisocyanate (IPDI), or dicyclohexylmethane diisocyanate (hydrogenated MDI), and impart energy to form a cross-linked structure.

The thickness of the skin layer 16 is appropriately selected according to the intended use of the skin material 10. For example, in a case in which polyurethane is used for forming the skin layer 16, the thickness of the skin layer 16 is approximately from 10 μm to 100 μm, and preferably in a range of from 20 μm to 80 μm.

In a case in which a vinyl chloride resin is used for forming the skin layer 16, the thickness of the skin layer 16 is approximately from 0.1 mm to 1.0 mm, and preferably in a range of from 0.2 mm to 0.6 mm.

The skin layer 16 may have, on the surface thereof, arbitrary uneven patterns (embossed patterns) such as natural leather-like embossed patterns.

The embossed patterns may be formed by forming the skin layer 16 on the ground fabric 12 via the adhesive layer 14, or performing pressure bonding to bond the ground fabric 12 and the layered body including the skin layer 16 or a precursor thereof, namely the layer of the composition for forming a skin layer, and applying heat thereto to cure the adhesive layer 14, and thereafter hot-pressing the resultant with an embossing transfer roll having an embossed pattern.

Alternatively, the embossed patterns may be formed by forming a layered body including a layer of a composition for forming a skin layer and a layer of a composition for forming an adhesive layer on a surface of a release material for transferring embossed patterns, on which an embossed pattern is formed in advance, bringing the adhesive layer 14, or a precursor thereof, namely the layer of the composition for forming an adhesive layer, of the obtained layered body, into contact with the ground fabric 12, hot-pressing the layered body and the base fabric 12, applying heat thereto, and thereafter peeling off the release material for transferring embossed patterns.

Any release material for transferring embossed patterns may be used as long as it has a desired embossed shape. As the release material for transferring embossed patterns, for example, a commercially available product may be used, or a release material that has, on the surface thereof, desired embossed patterns formed by computer graphics or the like may be used.

Any method known in the art may be used for forming the layer of the composition for forming a skin layer on the surface of the release material or on the surface of the release material for transferring embossed patterns.

In addition to a resin as a base compound, any known additive may be added to the composition for forming a skin layer as long as it does not adversely affect the effect of the invention, for the purpose of imparting various functions such as an improved texture to the skin layer.

Examples of the additive that can be used for the composition for forming a skin layer include a crosslinking agent, a crosslinking accelerator, a colorant, a film-forming agent, a flame retardant, and a blowing agent.

For example, in a case in which a colorant is added to the composition for forming a skin layer, a design feature may be improved. In a case in which a known flame retardant, such as a phosphorous flame retardant, a halogen flame retardant, or an inorganic metal flame retardant, is added, the flame resistance of the skin material may be improved.

The method of applying the composition for forming a skin layer to the surface of the release material for transferring embossed patterns may be a method of applying the composition for forming a skin layer onto a surface of the release material for transferring embossed patterns and drying the resultant, or may be a transfer method as long as the method does not disturb the transfer of embossed patterns.

Adhesive Layer

The skin layer 16 and the loop pile fabric 12 are bonded together via the adhesive layer 14.

An adhesive agent that constitutes the adhesive layer 14 is not particularly limited, and examples thereof include an adhesive agent containing polyurethane, an adhesive agent containing a vinyl chloride resin, and an adhesive agent containing an acrylic resin.

More specifically, preferable examples thereof include: (1) a two-component curable polyester adhesive agent, (2) a two-component curable polyurethane adhesive agent, and (3) a two-component curable acrylic adhesive agent.

The two-component curable polyurethane adhesive (2) may be a two-component curable polyether-based polyurethane adhesive, a two-component curable polyester-based polyurethane adhesive, or a two-component curable polycarbonate-based polyurethane adhesive.

The adhesive agent used for forming the adhesive layer may be a commercially available product. Preferable examples thereof include a welder adhesive No. 3660 (two-component curable polyurethane adhesive agent; No-tape Industrial Co., Ltd.), DAIKALAC 7250NT (two-component curable polyester adhesive agent; Daido Chemical Corporation), TA265 (two-component curable polyester adhesive agent; DIC Corporation), and CRISVON TA205 (polycarbonate-based polyurethane adhesive agent; DIC Corporation).

The composition for forming an adhesive layer used for forming the adhesive layer may include various additives in addition to the adhesive agent mentioned above according to the intended use, as long as it does not adversely affect the effect of the invention.

Examples of the additives include a colorant, a flame retardant, and a blowing agent.

The adhesive layer 14 may include bubbles.

In a case in which polyurethane is used for forming the adhesive layer 14, foamed polyurethane may be used as polyurethane. In a case in which foamed polyurethane is used for forming the adhesive layer 14, the adhesive layer 14 including bubbles can be obtained.

The adhesive layer 14 may be formed as an expandable layer by adding a blowing agent, such as a thermally expandable microcapsule, azodicarbonamide (ADCA), or the like to the composition for forming an adhesive layer. The blowing agent is expanded by heating at a heating process, whereby an adhesive layer including bubbles is formed as the adhesive layer.

Alternatively, bubbles may be formed in the composition for forming an adhesive layer by agitating mechanically the composition for forming an adhesive layer. Then the composition for forming an adhesive layer is cured by heating, whereby the bubbles are fixed in the adhesive layer to form the adhesive layer including bubbles.

In a case in which the adhesive layer 14 includes bubbles, the softness and cushioning characteristics of the obtained skin material 10 can be improved, and a lightweight and bulky skin material 10 can be obtained.

The thickness of the adhesive layer 14 formed using the composition for forming an adhesive layer is preferably in a range of from 50 μm to 300 μm in terms of dry film thickness.

In a case in which the composition for forming an adhesive layer includes a flame retardant such as a phosphorous flame retardant, the flame resistance of the skin material 10 can be improved. However, in a case in which the content of the flame retardant is too high, it is concerned that the softness of the obtained adhesive layer is decreased. Therefore, when a flame retardant is used in the composition for forming an adhesive layer, the content thereof is preferably 20% by mass or less with respect to the total amount of the composition for forming an adhesive layer.

The adhesive layer is formed by applying the composition for forming an adhesive layer to a surface of the skin layer, or to a surface of the layer of the composition for forming a skin layer. The method of applying the composition for forming an adhesive layer to the skin layer or to the layer of the composition for forming a skin layer may be a coating method or a transfer method

In this manner, the layered body having, on a surface of the release material, the layer of the composition for forming a skin layer and the layer of the composition for forming an adhesive layer, which are disposed, in the order, is produced. The surface of the layer of the composition for forming an adhesive layer of the layered body is brought into contact with a surface of the loop pile fabric 12 at a side at which the pile yarns 12B are provided, and then pressure is applied thereto.

The pressure applied to the layered body and the loop pile fabric 12 is preferably from 2 mPa to 20 kPa, and more preferably from 5 mPa to 2 kPa. When pressure is applied, it is preferable that pressure is applied after the layer of the composition for forming an adhesive layer is formed on the layer of the composition for forming a skin layer, but before the composition for forming an adhesive layer is cured, in terms of improving the peel strength between the loop pile fabric 12 and the skin layer 16 in the skin material.

The surface of the adhesive layer 14 of the layered body is brought into contact with a surface of the loop pile fabric 12, including fibers including polyester fibers, at a side at which the pile yarns 12B are provided, and then pressure is applied thereto. Thereafter, a heating process is performed, in which the pressure is released, and then the loop pile fabric 12 and the layered body are heated by a heating means and the layer of the composition for forming a skin layer and the layer of the composition for forming an adhesive layer are cured to form the skin layer 16 and the adhesive layer 14.

By bringing the loop pile fabric 12 into contact with the layered body and applying pressure thereto, top parts of the pile yarns 12B penetrate into the layer of the composition for forming an adhesive layer. When the pressure is released, a gap is formed between the ground structure 12A of the loop pile fabric 12 and the layer of the composition for forming an adhesive layer due to cushioning characteristics of the pile yarns 12B.

The heating process may be carried out by an ordinary method. The heating is performed for the purpose of drying the adhesive layer by volatilizing a solvent, and promoting a crosslinking reaction in the adhesive layer to cure the adhesive layer. The heating means used in the heating process is preferably a non-contact heating and drying means, such as hot-air drying or drying in a heating and drying oven. In a case in which contact heating is performed, it is preferable to use a single-side contact heating means, by which heating is carried out under conditions that avoid application of excessive pressure to the pile yarns 12B of the loop pile fabric 12; for example, by bringing a heating roll into contact with the side of the release material.

The drying temperature is preferably a temperature that does not affect the loop pile fabric 12, the adhesive layer 14, or the skin layer 16. For example, the drying temperature is preferably in a range of from 80° C. to 200° C., and more preferably in a range of from 90° C. to 170° C. The drying time is preferably from 0.5 minutes to 10 minutes, and more preferably from 1 minute to 5 minutes, under the temperature condition mentioned above.

The drying temperature condition and the drying time are not limited to the above examples, and an appropriate condition may be selected according to the type of a synthetic resin used for forming the skin layer 16 and the adhesive layer 14, the type of a fiber used for the loop pile fabric 12, or the like.

In a heating process, resins contained in the layer of the composition for forming a skin layer and the layer of the composition for forming an adhesive layer are cured to form the skin layer 16 and the adhesive layer 14. When a layer of the composition for forming an adhesive layer is cured, the gap between the adhesive layer 14 and the ground structure 12A of the loop pile fabric 12 is fixed, or in some cases, the gap is expanded due to the removable of a solvent, thermal contraction, or the like.

In a case in which the release material for transferring embossed patterns is used for forming embossed patterns, the skin layer 16 having embossed patterns on the surface thereof is formed on the loop pile fabric 12 via the adhesive layer 14 by peeling the release material for transferring embossed patterns after the heating process, whereby the skin material 10 according to the invention is produced.

Examples of other methods of forming embossed patterns on a surface of the skin layer 16 include a method of binding fabrics together using a smooth release material not having an embossed shape instead of the release material for transferring embossed patterns, peeling off the release material, and then bringing the layer of the composition for forming a skin layer in contact with a release material for transferring embossed patterns, so-called emboss roll, to form embossed patterns on a surface of the skin layer 16.

Other Layer

The skin material 10 according to the invention may include, in addition to the loop pile fabric 12, the adhesive layer 14, and the skin layer 16, other layer as long as it does not adversely affect the effect of the invention.

Examples of other layer include an intermediate layer and a surface treatment layer.

The surface treatment layer is formed by applying a surface treatment agent composition containing an aqueous emulsion resin or an organic solvent-based surface treatment agent composition onto a surface of the skin layer 16.

Any resin may be used as a resin for forming the surface treatment layer. For example, the resin used for forming the surface treatment layer is preferably polyurethane, an acrylic resin, or an elastomer, and more preferably polyurethane.

In a case in which the surface treatment agent layer is formed on the surface of the skin layer, the appearance can be further improved.

The surface treatment layer may contain a crosslinking agent, an organic filler, a lubricant, a flame retardant, or the like. For example, in a case in which the surface treatment layer includes an organic filler, a lubricant, or the like, the smooth tactile sensation is imparted to the skin material and the abrasion resistance can be further improved.

In the skin material 10 according to the invention, the intermediate layer may be provided between the adhesive layer 14 and the skin layer 16.

In a case in which a polyurethane foam layer or a polyvinyl chloride foam layer is provided as the intermediate layer, the cushioning characteristics of the skin material may be further improved.

Examples of polyurethane that can be used as the intermediate layer include polycarbonate-based polyurethane, polyether-based polyurethane, polyester-based polyurethane, and a modified product thereof. In a case in which long term durability is required, polycarbonate-based polyurethane is preferable. The intermediate layer as a polyurethane foam layer can be obtained by generating bubbles in polyurethane using an ordinary method.

The thickness of the polyurethane intermediate layer may be set in a range of from 10 μm to 200 μm. The thickness is preferably in a range of from 10 μm to 100 μm, and more preferably in a range of from 30 μm to 60 μm.

The hardness of polyurethane that can be used as the intermediate layer is preferably from 0.98 MPa to 11.76 MPa in terms of 100% modulus.

The thickness of the intermediate layer as the polyvinyl chloride resin foam layer may be set in a range of from 100 μm to 500 μm. The thickness is preferably in a range of from 150 μm to 350 μm.

The degree of polymerization of the vinyl chloride resin that can be used as the intermediate layer is preferably in a range of from 700 to 2000.

Method of Producing Skin Material

Hereinbelow, the method of producing a skin material according to the second embodiment of the invention is described.

In is preferable that the skin material 10 according to the invention is produced by a method of producing a skin material, the method including a layered body forming process of forming a layered body having, on a surface of a release material, a layer of a composition for forming a skin layer and a layer of a composition for forming an adhesive layer, by applying the composition for forming a skin layer onto the surface of the release material, to form the layer of the composition for forming a skin layer, and applying the composition for forming an adhesive layer onto a surface of the layer of the composition for forming a skin layer, to form a layer of the composition for forming an adhesive layer; a pressurizing process of bringing the layer of the composition for forming an adhesive layer of the obtained layered body, into contact with a surface of the loop pile fabric 12, including fibers including polyester fibers, at a side at which the pile yarns 12B are provided, and applying pressure thereto; and a heating process of releasing the pressure applied to the loop pile fabric and the layered body and thereafter applying heated thereto with a heating means, such that the layer of the composition for forming a skin layer and the layer of the composition for forming an adhesive layer are cured to form the skin layer 16 and the adhesive layer 14.

The obtained skin material 10 includes the loop pile fabric 12, including fibers including polyester fibers, and the adhesive layer 14 and the skin layer 16, which are disposed, in this order, on a surface of the loop pile fabric at a side at which the pile yarns 12B are provided, in which at least top parts of the pile yarns 12B are located in the adhesive layer 14, and a gap is formed between the ground structure 12A of the loop pile fabric 12 and the adhesive layer 14.

In the above producing method, the pressurizing process and the subsequent heating process is preferably performed immediately after the formation of the layer of the composition for forming a skin layer and the layer of the composition for forming an adhesive layer.

Specifically, it is preferable to perform the pressurizing process and the heating process while the layer of the composition for forming an adhesive layer is still uncured. In a case in which the layer of the composition for forming an adhesive layer is brought into contact with the pile yarns 12B of the loop pile fabric 12 and pressure is applied thereto while the layer is still uncured, the top parts of the pile yarns 12B can easily penetrate into the layer of the composition for forming an adhesive layer. The layer of the composition for forming an adhesive layer is then cured to form the adhesive layer 14, and the top parts of the pile yarns 12B are fixed in a state in which they are located in the adhesive layer 14. As a result, the adherence between the adhesive layer 14 and the loop pile fabric 12 can be improved, and the peel strength between the fabric. i.e., the loop pile fabric 12, and the skin layer 16 can also be improved.

According to a preferable aspect of the invention, the adhesive layer 14 may include bubbles.

The method of forming the adhesive layer 14 including bubbles is not particularly limited. For example, the adhesive layer 14 including bubbles may be formed by using a composition for forming an adhesive layer that includes a synthetic resin such as polyurethane and a blowing agent, and in the heating process, curing a layer of a composition for forming a skin layer and a layer of the composition for forming an adhesive layer and expanding a blowing agent contained in the layer of the composition for forming an adhesive layer.

Alternatively, the adhesive layer 14 including bubbles may be formed by mechanically agitating the composition for forming an adhesive layer to generate bubbles, and thereafter forming a layer of the composition for forming an adhesive layer including bubbles and curing the layer by heating.

In a case in which the adhesive layer 14 includes bubbles, the cushioning characteristics of the obtained skin material 10 can be improved.

Since the skin material 10 according to the invention has a soft texture, an appropriate elasticity, and improved peel strength between the base material and the skin layer, the applicable fields thereof are broad, including automobile interior parts, interior parts of train vehicles and aircrafts, skin materials for furniture, shoes, footwear, bags, etc., interior or exterior materials for construction, outer covering materials or linings for clothes, wall covering materials, and the like. The skin material 10 according to the invention has excellent durability and cushioning characteristics, and therefore is suitable for a skin material for a seat such as an automobile seat or a chair.

### EXAMPLES

Hereinbelow, an exemplary embodiment of the invention is described more specifically by reference to examples. In should be noted that the invention is not limited to these examples.

### Example 1

### 1. Formation of Layered Body

As a release material, Release Paper ARX196M (trade name, produced by Asahi Roll Co., Ltd.) was used. On a surface of the release material, polyurethane (trade name: CRISVON NY-324, produced by DIC Corporation) diluted with a 1:1 (mass ratio) mixed solvent of dimethylformamide (DMF)/methyl ethyl ketone (MEK) to a solid content of 15% by mass was applied in an amount of 200 g/m² using a knife coater. The resultant was dried in a heating oven at 100° C. for 2 minutes, thereby forming a skin layer 16 with a thickness of approximately 30 μm on the surface of the release material.

An adhesive (trade name: CRISVON TA-205, produced by DIC Corporation) was diluted with the mixed solvent to a solid content of 30% by mass, and further a crosslinking agent (BURNOCK DN980, produced by DIC Corporation), and an accelerator (ACCEL T, produced by DIC Corporation) were added thereto in predetermined amounts, thereby obtaining a composition A for forming an adhesive layer.

The obtained composition A for forming an adhesive layer was subsequently applied in an amount of 280 g/m² to a surface opposite to the side of the release material of the skin layer 16 formed on the surface of the release material, thereby obtaining a layer of the composition for forming an adhesive layer with a thickness of approximately 85 μm.

### 2. Production of Skin Material

Immediately after the formation of the layer of the composition for forming an adhesive layer, the layer of the composition for forming an adhesive layer was brought into contact with a surface of a loop pile fabric 12 (wrap sinker knit, pile yarn fineness: 75 d/36 fdex, sinker height 1.0 mm, produced by Shinwa Co.), at a side at which pile yarns 12B are provided, and the obtained laminate was subjected to pressure bonding at a pressure of 20 mPa. Subsequently, the resultant was dried and cured in a heating oven at 170° C. for 2 minutes, and thereafter the release material was peeled off, thereby obtaining a skin material 10 of Example 1 having a structure as shown in FIG. 1 in which the skin layer 16 was formed on the surface of the loop pile fabric 12 via the adhesive layer 14. By the observation of a cross-section of the skin material, it was found that a gap of approximately 50 μm was formed between a ground structure 12A of the loop pile fabric 12 and the adhesive layer 14.

### Example 2

A skin material of Example 2 was obtained in the same manner as Example 1 except that a composition B for forming an adhesive layer prepared as follows was used instead of the composition A for forming an adhesive layer used in Example 1.

### Preparation of Composition B for Forming Adhesive Layer

An adhesive (trade name: CRISVON TA-205, produced by DIC Corporation) was diluted with the mixed solvent to a solid content of 30% by mass, and further prescribed amounts of crosslinking agent (BURNOCK DN980, produced by DIC Corporation) and accelerator (ACCEL T, produced by DIC Corporation) and 2% by mass of a blowing agent (NEOCELLBORN N#1000M, produced by Eiwa Chemical Ind., Co., Ltd.) were added thereto, thereby obtaining an composition for forming an adhesive layer.

The adhesive layer in the skin material of Example 2 includes bubbles formed by expansion of the blowing agent through heating in a heating oven.

### Example 3

### Preparation of Composition C for Forming Adhesive Layer

An adhesive (trade name: CRISVON TA-205, produced by DIC Corporation) was diluted with the mixed solvent to a solid content of 30% by mass, and further a crosslinking agent (BURNOCK DN980, produced by DIC Corporation), and an accelerator (ACCEL T, produced by DIC Corporation) were added thereto in prescribed amounts, thereby obtaining a composition C for forming an adhesive layer.

The composition C for forming an adhesive layer that has a specific gravity of 0.5 g/cm³ and includes bubbles with an average particle diameter of from 50 μm to 100 μm was prepared by mixing using a planetary mixer at 50 rpm for 30 minutes before coating the composition C for forming an adhesive layer.

Production of Skin Material

A skin material of Example 3 was obtained in the same manner as Example 1 except that the composition C for forming an adhesive layer including bubbles prepared as above was used instead of the composition A for forming an adhesive layer used in Example 1.

The adhesive layer in the skin material of Example 3 includes bubbles formed by mechanical foaming.

### Comparative Example 1

A raising process was applied to a polyester woven fabric (trade name: MT508PX, produced by TSUYAEI) using a card clothing, thereby obtaining a polyester fabric with raised naps having a fineness of approximately 75 dTex, and a length of 100 μm.

A skin material of Comparative Example 1 was obtained in the same manner as Example 1 except that the obtained polyester woven fabric applied to the raising process was used as the ground fabric 12 instead of the loop pile fabric used in Example 2.

### Comparative Example 2

A raising process was applied to a polyester tricot-knitted fabric (trade name: TL1531PX, produced by TSUYAEI) using a card clothing, thereby obtaining a polyester tricot-knitted fabric with raised naps having a fineness of approximately 75 dTex, and a length of 100 μm.

A skin material of Comparative Example 2 was obtained in the same manner as Example 2 except that the obtained polyester tricot-knitted fabric applied to the raising process was used as the ground fabric 12 instead of the loop pile fabric used in Example 1.

Evaluation of Obtained Skin Material

With respect to the skin materials of Examples and Comparative Examples, the following items were evaluated. The results are shown in Table 1.

### 1. Rebound Resilience

The rebound resilience was measured according to JIS K 6255 (2013), “Rubber, vulcanized or thermoplastic-Determination of rebound resilience”.

### 2. Peel Strength

According to JIS K 6404-5, “Test methods for Rubber- or plastics-coated fabrics”, the 180 degree peel strength between the fabric and the layered body of the skin layer and the adhesive layer was measured. A higher value of the peel strength was evaluated as preferable, and a peel strength of 40.0 N/3 cm or higher is acceptable for practical use.

### 3. Stiffness

The stiffness of the skin material was measured by a Gurley method or a slide method according to the leather softness test method of JIS K 6542 (1974). A lower value of the stiffness is evaluated as softer.

### 4. Texture

The texture of the skin material (50 cm×50 cm—namely, the smooth tactile sensation of a surface, flexibility in bending, and the like—was evaluated by 10 monitors, and evaluated according to the following criteria.

### Criteria

Very good: evaluated favorably by 8 or more members among the 10 monitors.

Good: evaluated favorably by 5 to 7 members among the monitors.

Slightly poor: evaluated favorably by 1 to 4 members among the monitors.

Poor: evaluated favorably by 0 members among the monitors. (None of the monitors provided a favorable evaluation.)

### 5. Comprehensive Evaluation

A: The texture is favorable, the peel strength is high, and has a practical use.

B: The texture is favorable, but the peel strength is low and not acceptable for practical use.

C: The texture is poor and the rebound resilience coefficient is low, and not acceptable for practical use.

With respect to the above criteria, the criterion A is acceptable for practical use.

TABLE 1

| | Rebound | | | | |
|---|---|---|---|---|---|
| | resilience | Peel | | | Compre- |
| | coefficient | strength | | | hensive |
| | (gf · cm/cm²) | (N/3 cm) | Stiffness | Texture | Evaluation |
| Example 1 | 2.5 | 50 | 35 | Good | A |
| Example 2 | 2.1 | 45 | 37 | Good | A |
| Example 3 | 2.8 | 40 | 40 | Good | A |
| Comparative | 0.9 | 23 | 35 | Poor | C |
| Example 1 | | | | | |
| Comparative | 0.8 | 21 | 38 | Poor | C |
| Example 2 | | | | | |

As obvious from Table 1, the skin materials of Example 1 to Example 3 had an appropriate rebound resilience and superior cushioning characteristics compared to the skin materials of Comparative Examples. It was found that the skin materials of Example 1 to Example 3 have a soft texture and an appropriate softness compared to the skin materials of Comparative Examples.

On the other hand, the skin materials of Comparative Example 1 and Comparative Example 2 using a fabric having raised fibers had a low rebound resilience and inferior cushioning characteristics, and the peel strengths were also low compared to Examples.

From the above evaluations, it has been confirmed that the skin materials of Example 1 to Example 3 are suitable for uses such as an automobile seat.

The disclosure of Japanese Patent Application No. 2014-266544 filed on Dec. 26, 2014 is incorporated herein by reference. All publications, patent applications, and technical standards mentioned in this specification are herein incorporated to the same extent as if each individual publication, patent application, and technical standard was specifically and individually indicated to be incorporated by reference.

1. A skin material comprising:
a loop pile fabric comprising fibers including polyester fibers, and
an adhesive layer and a skin layer, which are disposed, in this order, on a surface of the loop pile fabric at a side at which pile yarns are provided,
wherein at least top parts of the pile yarns are located in the adhesive layer, and a gap is formed between a ground structure of the loop pile fabric and the adhesive layer.

2. The skin material according to claim 1, wherein, in the loop pile fabric, the pile yarns are provided on one side of the ground structure.

3. The skin material according to claim 1 or 2, wherein the adhesive layer comprises polyurethane.

4. The skin material according to any one of claims 1 to 3, wherein the adhesive layer includes bubbles.

5. A method of producing a skin material, the method comprising:
a layered body forming process of forming a layered body having, on a surface of a release material, a layer of a composition for forming a skin layer and a layer of a composition for forming an adhesive layer, by applying the composition for forming a skin layer onto the surface of the release material, to form the layer of the composition for forming a skin layer, and applying the composition for forming an adhesive layer onto a surface of the layer of the composition for forming a skin layer, to form the layer of the composition for forming an adhesive layer;
a pressurizing process of bringing the layer of the composition for forming an adhesive layer of the obtained layered body, into contact with a surface of a loop pile fabric, comprising fibers including polyester fibers, at a side at which pile yarns are provided, and applying pressure thereto; and
a heating process of releasing the pressure applied to the loop pile fabric and the layered body and thereafter applying heat thereto, such that the layer of the composition for forming a skin layer and the layer of the composition for forming an adhesive layer are cured to form a skin layer and an adhesive layer,
wherein the skin material comprises the loop pile fabric, comprising fibers including polyester fibers, and the adhesive layer and the skin layer, which are disposed, in this order, on a surface of the loop pile fabric at a side at which pile yarns are provided, at least top parts of the pile yarns are located in the adhesive layer, and a gap is formed between a ground structure of the loop pile fabric and the adhesive layer.

6. A method of producing a skin material, the method comprising:
a layered body forming process of forming a layered body having, on a surface of a release material, a layer of a composition for forming a skin layer and a layer of a composition for forming an adhesive layer, by applying the composition for forming a skin layer onto the surface of the release material, to form the layer of the composition for forming a skin layer, and applying the composition for forming an adhesive layer onto a surface of the layer of the composition for forming a skin layer, to form a layer of the composition for forming an adhesive layer;
a pressurizing process of drying the layer of the composition for forming a skin layer and the layer of the composition for forming an adhesive layer by heating the obtained layered body with a heating means, and thereafter bringing a surface of a loop pile fabric, comprising fibers including polyester fibers, at a side at which pile yarns are provided into contact with the layer of the composition for forming an adhesive layer of the obtained layered body, and applying pressure thereto; and
a process of releasing the pressure applied to the loop pile fabric and the layered body,
wherein the skin material comprises the loop pile fabric, comprising fibers including polyester fibers, and the adhesive layer and the skin layer, which are disposed, in this order, on a surface of the loop pile fabric at a side at which pile yarns are provided, at least top parts of the pile yarns are located in the adhesive layer, and a gap is formed between a ground structure of the loop pile fabric and the adhesive layer.

7. The method of producing a skin material according to claim 5 or 6, wherein the heating means is a non-contact heating means or a single-side contact heating means.

8. The method of producing a skin material according to any one of claims 5 to 7, wherein the heating with a heating means comprises forming an adhesive layer including bubbles by expanding a blowing agent contained in the layer of the composition for forming an adhesive layer, or by fixing bubbles contained in the layer of the composition for forming an adhesive layer.
